(19) United States
(12) Patent Application Publication
(10) Pub. No.: US 2014/0046838 A1
(43) Pub. Date: Feb. 13, 2014

(54) SYSTEM AND METHOD FOR BENEFICIARY CONTROLLED USE OF PAID BENEFITS

(71) Applicants: Jennifer DOGIN, Mamaroneck, NY (US); Brian Maw, Norwalk, CT (US)

(72) Inventors: Jennifer DOGIN, Mamaroneck, NY (US); Brian Maw, Norwalk, CT (US)

(73) Assignee: MASTERCARD INTERNATIONAL INCORPORATED, Purchase, NY (US)

(21) Appl. No.: 13/571,857

(22) Filed: Aug. 10, 2012

(51) Int. Cl. G06Q 20/34; G06Q 40/00

(52) U.S. Cl. 705/41; 705/35

(57) ABSTRACT

A method for distributing a controlled payment number includes: storing a financial account, the account including a payment card number and a beneficiary; offering a controlled payment number, wherein the number can be controlled based on at least one of a plurality of payment card use conditions; receiving, from the beneficiary, a request for a controlled payment number, the request including an indication of at least one payment card use condition; transmitting the payment card number and the at least one payment card use condition; receiving a controlled payment number associated with the at least one payment card use condition; associating the controlled payment number with the financial account; and distributing the controlled payment number, wherein the controlled payment number is subject to the at least one payment card use condition and the payment card number is not subject to the at least one payment card use condition.

### FIELD

The present disclosure relates to the controlled use of benefits paid to a beneficiary, specifically using controlled payment numbers with controls set by a beneficiary to provide for the secure use of benefits provided by a benefits agency for an authorized user on the beneficiary's behalf.

### BACKGROUND

Traditionally, benefits agencies would often provide financial benefits to beneficiaries by mailing checks, which the beneficiary could cash and then use, which is both expensive and leads to problems in misuse of the funds by the beneficiary or he or her health care providers. Further, in some instances, when time may be of the essence, such as a beneficiary for medical benefits who is in need of medication, the beneficiary may have been forced to pay for expenses personally and then be reimbursed by the benefits agency. The amount of processing necessary, as well as the labor and expense in printing and distributing checks, could add up to a considerable amount.

In an effort to streamline the process of distributing benefits to a beneficiary, in more modern times many benefits agencies have resorted to issuing payment cards to beneficiaries. These payment cards may be reloadable pre-paid cards, credit cards, debit cards, etc. where the beneficiary can use the card and have the expense covered by the benefits agency. The use of payment cards may result in faster processing by the benefits agency, such as the immediate funding of a payment card so that the beneficiary in not inconvenienced with needing to cash a check or hold a banking account, and not inconvenienced in that he or she does not have to use his or her own expenses even in instances where there is short notice. This can be especially important for beneficiaries who cannot afford large expenses and would not otherwise be able to obtain time-sensitive products or services, such as medication or health services. The use of payment cards may also be less expensive for the benefits agency due to the removal of paper checks and postage expenses.

However, while the use of payment cards for the distribution of benefits may provide a lot of advantages to beneficiaries, problems still exist in many current benefit distribution systems. In particular, many beneficiaries of medical benefits may be at a disadvantage by the use of benefit-funded payment cards. Many beneficiaries may rely on others, such as health care providers, friends, family, public assistance, etc. for the purchase of services or goods, such as medication, using benefit-funded payment cards. Some beneficiaries may be physical unable to purchase much needed medication, such as a beneficiary without reliable transportation or a beneficiary that is unable due to illness or injury. These beneficiaries may rely on third parties by giving them their benefit-funded payment card. This process can also lead to problems with respect to recognizing the beneficiaries helper as having the authority or authorization to act on behalf of the beneficiary, such as when picking up prescriptions.

A problem may arise when payment cards do not have adequate measures in place to stop a third party from taking advantage of the beneficiary, who may use the payment card for personal or otherwise unauthorized expenses. The beneficiary may not learn of these unauthorized purchases or charges until a later time, which may prevent the beneficiary from receiving necessary goods or services. In some instances, a beneficiary may be able to monitor the use of the payment card, such as through the Internet or telephone, but many beneficiaries may not have ready access to communication or may otherwise be unable to actively monitor their benefits accounts, such as due to the illness for which they need assistance. This may result in those beneficiaries who need assistance the most being the ones most vulnerable to fraudulent behavior by third parties. Thus, there is a perceived opportunity to improve the technology of providing benefits paid to beneficiaries, by providing beneficiaries with computer based controls that may be placed on the use of payment cards issued to the beneficiary by a benefits agency.

### SUMMARY

The present disclosure provides a description of a systems and methods for distributing and processing controlled payment numbers for financial transactions.

A method for distributing a controlled payment number by a benefits agency includes: storing, in a database, at least one financial account, wherein the at least one financial account includes a payment card number and a beneficiary; offering, to the beneficiary, at least one controlled payment number, wherein the at least one controlled payment number can be controlled based on at least one of a plurality of payment card use conditions; receiving, from the beneficiary, a request for a controlled payment number, wherein the request for a controlled payment number includes an indication of at least one payment card use condition of the plurality of payment card use conditions; transmitting, to the third party, at least the payment card number and the desired at least one payment card use condition; receiving, by the receiving device, a controlled payment number associated with the at least one payment card use condition; associating, in the database, the received controlled payment number with the at least one financial account; and distributing, to the beneficiary, the received controlled payment number, wherein the received controlled payment number is subject to the at least one payment card use condition and the payment card number is not subject to the at least one payment card use condition.

A method for processing a financial transaction using a controlled payment number includes: storing, in a conditions database, a plurality of payment card use conditions; transmitting, by a transmitting device, the plurality of payment card use conditions; receiving, by a receiving device, a request for a controlled payment number, wherein the request for a controlled payment number includes at least the payment card number and at least one payment card use condition of the plurality of payment card use conditions; identifying, by a processing device, a controlled payment number; associating, in an account database, the controlled payment number with the payment card number and the at least one payment card use condition; transmitting, by the transmitting device, the controlled payment number; receiving, by the receiving device, an authorization request for a financial transaction, wherein the authorization request includes at least the controlled payment number; and processing the financial transaction using the payment card number associated with the controlled payment number.

A system for distributing a controlled payment number by a benefits agency includes a database, a transmitter, a receiver, and a processor. The database is configured to store at least one financial account, wherein the at least one financial account includes a payment card number and a beneficiary. The transmitter is configured to transmit, to the beneficiary, a plurality of payment card use conditions for selection in obtaining at least one controlled payment number. The receiver is configured to receive, from the beneficiary, a request for a controlled payment number, wherein the request for a controlled payment number includes at least an indication of at least one payment card use condition of the plurality of payment card use conditions, and receive a controlled payment number. The transmitter is further configured to transmit, to the third party, at least the payment card number and the desired at least one payment card use condition. The processor is configured to associate, in the database, the received controlled payment number with the at least one financial account, and distribute, to the beneficiary, the received controlled payment number, wherein the received controlled payment number is subject to the at least one payment card use condition and the payment card number is not subject to the at least one payment card use condition.

A system for processing a financial transaction using a controlled payment number includes a conditions database, a transmitter, a receiver, a processor, and an account database. The conditions database is configured to store a plurality of payment card use conditions. The transmitter is configured to transmit the plurality of payment card use conditions. The receiver is configured to receive a request for a controlled payment number, wherein the request for a controlled payment number includes at least a payment card number and at least one payment card use condition of the plurality of payment card use conditions. The processor is configured to: identify a controlled payment number; associate, in the account database, the controlled payment number with the payment card number and the at least one payment card use condition; cause the transmitter to transmit the controlled payment number; cause the receiver to receive an authorization request for a financial transaction, wherein the authorization request includes at least the controlled payment number; and process the financial transaction using the payment card number associated with the controlled payment number.

### BRIEF DESCRIPTION OF THE DRAWING FIGURES

Exemplary embodiments are best understood from the following detailed description when read in conjunction with the accompanying drawings. Included in the drawings are the following figures:

FIG. 1 is a block diagram illustrating a system for distributing a controlled payment number to beneficiary for use by an authorized user in accordance with exemplary embodiments.

FIG. 2 is a block diagram illustrating a server of the benefits agency of FIG. 1 in accordance with exemplary embodiments.

FIG. 3 is a block diagram illustrating a server of the financial transaction processing agency of FIG. 1 in accordance with exemplary embodiments.

FIG. 4 is a table illustrating data for controlled use controlled payment numbers stored in a financial account or payment account database in accordance with exemplary embodiments.

FIGS. 5A and 5B are a flow diagram illustrating a method for issuing a controlled payment number to a beneficiary in accordance with exemplary embodiments.

FIGS. 6A and 6B are a flow diagram illustrating a method for processing a financial transaction using a controlled payment number issued to a beneficiary in accordance with exemplary embodiments.

FIG. 7 is a block diagram illustrating system architecture of a computer system in accordance with exemplary embodiments.

FIG. 8 is a flow chart illustrating an exemplary method for distributing a controlled payment number by a benefits agency in accordance with exemplary embodiments.

FIG. 9 is a flow chart illustrating an exemplary method for processing a financial transaction using a controlled payment number distributed by a benefits agency in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Distribution and Processing of Controlled Payment Numbers

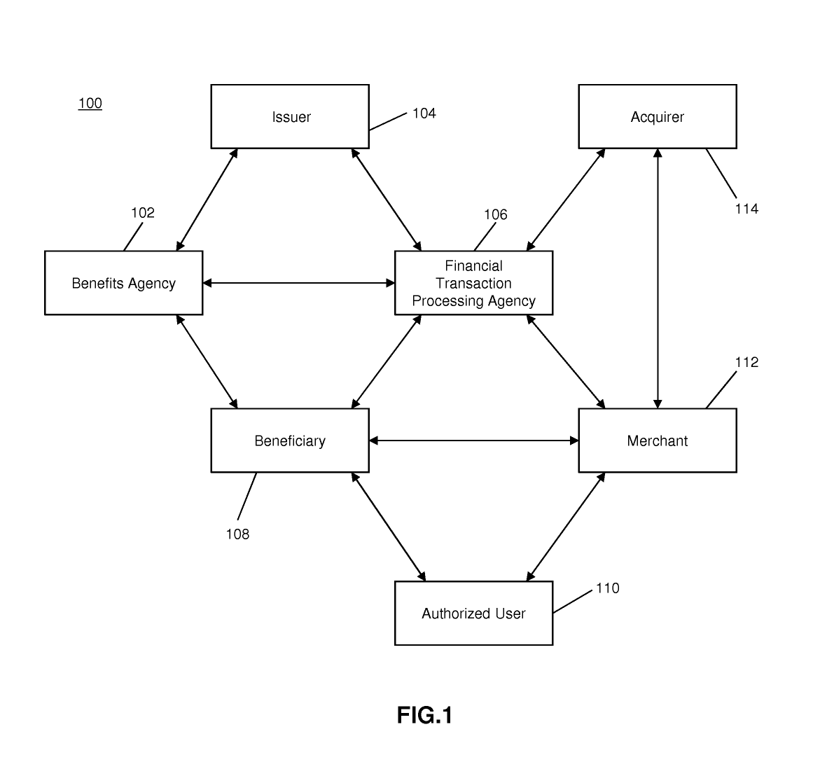

FIG. 1 illustrates a system 100 for the distribution of controlled payment numbers from a benefits agency 102 to a beneficiary 108, which may be used in a financial transaction between an authorized user 110 of the beneficiary 108 and a merchant 112, and processed by a financial transaction processing agency 106.

In the system 100, an issuer 104 may issue a payment card to the benefits agency 102. The issuer 104 may be a financial institution that issues payment cards to third parties, such as an issuing bank. The benefits agency 102 may be any type of agency, such as a governmental agency (e.g., the Social Security Administration), a non-governmental organization, or other type of agency, that may distribute financial benefits to a beneficiary (e.g., the beneficiary 108). The payment card issued by the issuer 104 to the benefits agency 102 may be a credit card, debit card, or any other type of payment card suitable for performing the functions as disclosed herein as will be apparent to persons having skill in the relevant art.

The benefits agency 102 may associate the payment card with the beneficiary 108, such as in a database as discussed in more detail below. Further, the benefits agency, either on its own or using the issuer 104 or a financial transaction processing agency 106 as service providers, and distribute Controlled Payment Numbers (CPNs) that are not regular payment cards issued from the issuer 104, as explained below. Rather virtual or tangible CPNs associated with the beneficiary's payment card such that when CPN is used, it is routed to a database server, checked against various set controls including any user defined controls, and if the attempted use is in compliance with the controls on use, the CPN is swapped out for the payment card number and processed as a regular transaction, as explained below. Controls on the use of plastic and/or virtual credit cards, particular user defined controls, and be found in, for example, U.S. Pat. Nos. 7,895,122; 7,593,896; 7,571,142; 7,567,934; 7,433,845; 7,136,835; and 6,636,833, herein incorporated by reference.

The benefits agency 102 may receive, from the financial transaction processing agency 106, a plurality of payment card use conditions, discussed in more detail below. The benefits agency 102 may transmit to the beneficiary 108 the plurality of payment card use conditions or some subset thereof, from which the beneficiary 108 may select at least one payment card use condition to be placed on a controlled payment number, whether the payment card, any associated CPN(s) or both. The benefits agency 102 may set some of the conditions as automatically in place that are conditions for receiving the benefits, particularly foreseeable as to negative conditions such as what products cannot be purchased and what merchants or merchant categories are not permitted. In some embodiments, the beneficiary 108 may transmit the desired at least one payment card use condition to the benefits agency 102 via a request via the Internet, over the telephone or in written form, or any other suitable communication path.

In one embodiment, the benefits agency 102 may transmit the payment card use condition(s) selected by the beneficiary 108 as well as payment card information (e.g., a unique payment card number) associated with the payment card associated with the beneficiary 108, to the financial transaction processing agency 106. The financial transaction processing agency 106 may identify a controlled payment number that is controlled based on the selected payment card use condition(s) and transmit the identified controlled payment number to the benefits agency 102. The financial transaction processing agency 106 (e.g., and the benefits agency 102) may associated the identified CPN with the payment card associated with the beneficiary 108.

The benefits agency 102 may distribute the received CPN to the beneficiary 108. The beneficiary 108 may then provide the controlled payment number (e.g., an electronic number, or a payment card with the CPN displayed and/or encoded on the card, etc.) to the authorized user 110. The authorized user 110 may be any user (e.g., a person, corporation, etc.) whom the beneficiary 108 wants to use benefits account on his or her behalf. For example, the authorized user 110 may be a nurse or other home health care provider that needs to purchase a subscription for the beneficiary 108. The authorized user 110 may engage in a financial transaction with the merchant 112 using the controlled payment number. The CPN that is associated with both the beneficiary and the authorized used (e.g., both names listed on a tangible CPN) can act as a form of authority for the caregiver to act on behalf of the beneficiary.

The merchant 112 (e.g., or an acquirer 114, such as an acquiring bank operating on behalf of the merchant 112) may transmit an authorization request, including the controlled payment number, for the financial transaction to the financial transaction processing agency 106. The financial transaction processing agency 106 may determine if the financial transaction satisfies the payment card use conditions associated with the controlled payment number. If it does not, the financial transaction processing agency 106 may deny the financial transaction (e.g., and notify the merchant 112). If the transaction satisfies the payment card use conditions, the financial transaction processing agency 106 may identify the payment card number associated with the controlled payment number. The financial transaction processing agency 106 may then process the financial transaction using the payment card number. Methods for processing financial transactions using payment card numbers will be apparent to persons having skill in the relevant art and from the above list of patents.

Each of the components in the system 100 may communicate via a network. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art.

### Benefits Agency

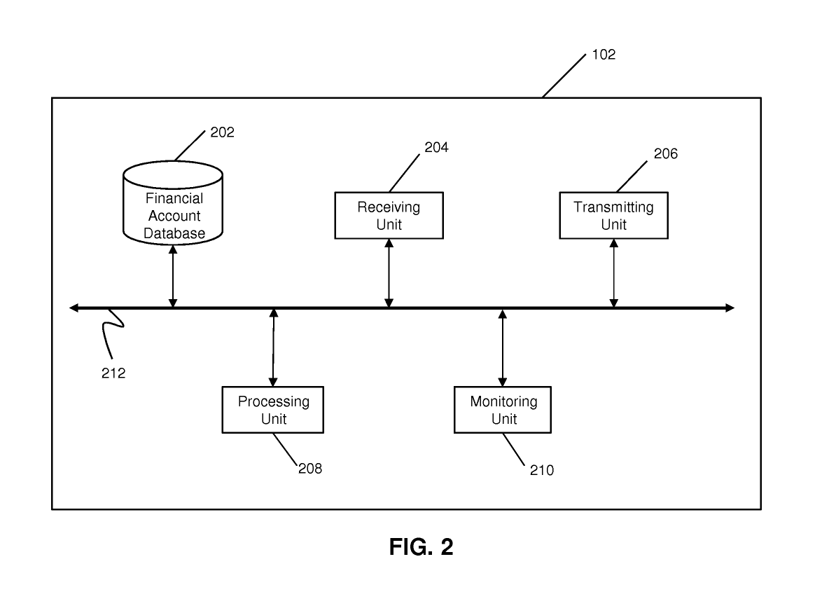

FIG. 2 illustrates system architecture for a server operating as the benefits agency 102. The benefits agency 102 may include a financial account database 202. The financial account database 202 may include a plurality of financial accounts associated with beneficiaries, such as the beneficiary 108. Each financial account may include a beneficiary (e.g., the beneficiary 108) and an associated payment card number, such as a payment card number issued by the issuer 104. Some financial accounts may also include at least one controlled payment number associated with the beneficiary 108. In some embodiments, the financial accounts may also include payment card use conditions associated with each controlled payment number.

The benefits agency 102 may also include a receiving unit 204, a transmitting unit 206, a processing unit 208, and a monitoring unit 210. Each of the components may be connected via a bus 212. Suitable types and configurations of the bus 212 will be apparent to persons having skill in the relevant art. The receiving unit 204 may be configured to receive (e.g., from the financial transaction processing agency 106) a plurality of payment card use conditions. The transmitting unit 206 may be configured to transmit (e.g., to the beneficiary 108) at least one of the plurality of payment card use conditions for selection by the beneficiary 108 for the controlled use of a controlled payment number.

The receiving unit 204 may be further configured to receive (e.g., from the beneficiary 108) a request for a controlled payment number, the request including at least one payment card use condition to be associated with the controlled payment number. The transmitting unit 206 may be configured to transmit (e.g., to the financial transaction processing agency 106) the request for the controlled payment number including the payment card number associated with the beneficiary 108 and stored in the financial account database 202. The receiving unit 204 may be configured to in turn receive a controlled payment number that is subject to the at least one payment card use condition as requested by the beneficiary 108.

The processing unit 208 may be configured to associate, in the financial account database 202, the payment card number corresponding to the beneficiary 108 with the received controlled payment number. The processing unit 208 may further store the at least one payment card use condition associated with the controlled payment number in the financial account database 202. The monitoring unit 210 may be configured to monitor the use of the controlled payment number and/or payment card number. Monitoring the controlled payment number may include notifying the beneficiary 108 of its use in financial transactions, identifying remaining funding amounts for prepaid payment cards and payment numbers, etc. Other monitoring functions performed by the benefits agency 102 will be discussed in more detail below.

### Financial Transaction Processing Agency

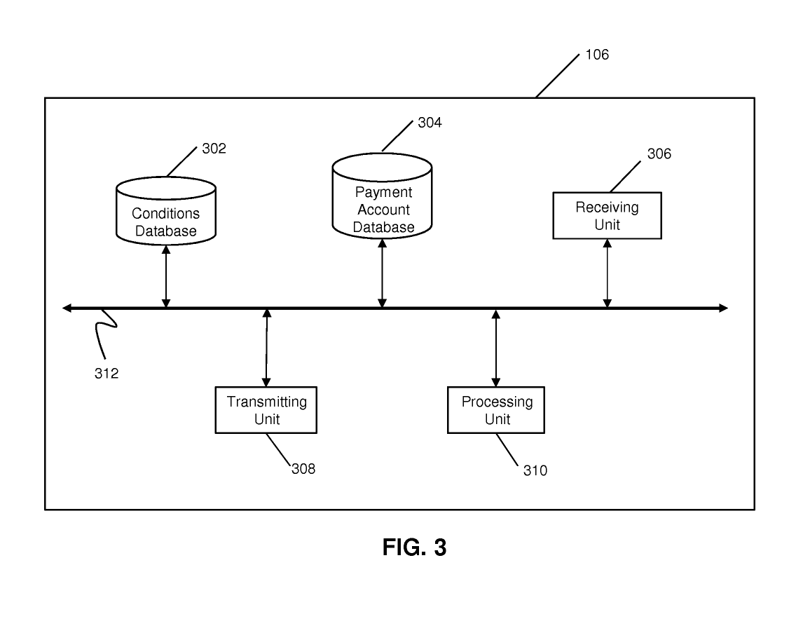

FIG. 3 illustrates system architecture for the financial transaction processing agency 106. The financial transaction processing agency 106 may include a conditions database 302, a payment account database 304, a receiving unit 306, a transmitting unit 308, and a processing unit 310. Each of the components may be connected via a bus 312. Suitable types and configurations of the bus 312 will be apparent to persons having skill in the relevant art.

The conditions database 302 may be configured to store a plurality of payment card use conditions. Payment card use conditions may be conditions that may be placed on a controlled payment number such that the conditions may be satisfied prior to the use of the controlled payment number in a financial transaction. Payment card use conditions may include authorized users, prohibited user, authorized merchants, prohibited merchants, authorized transaction amounts, authorized dates and/or times, transaction amount limits, number of transaction limits, aggregate transaction amount limits, geographic restrictions, etc. Payment card use conditions that may be used may depend on the type of financial account for which the controlled payment number may apply, the limitations desired by the requester, limitations of the issuer 104 or the benefits agency 102, etc. For example, a beneficiary 108 may request a controlled payment number that may only be used by a specific authorized user (e.g., the authorized user 110), at a particular merchant (e.g., the merchant 112), and on a particular date. Additional conditions that may suitable for use in controlling a controlled payment number will be apparent to persons having skill in the relevant art.

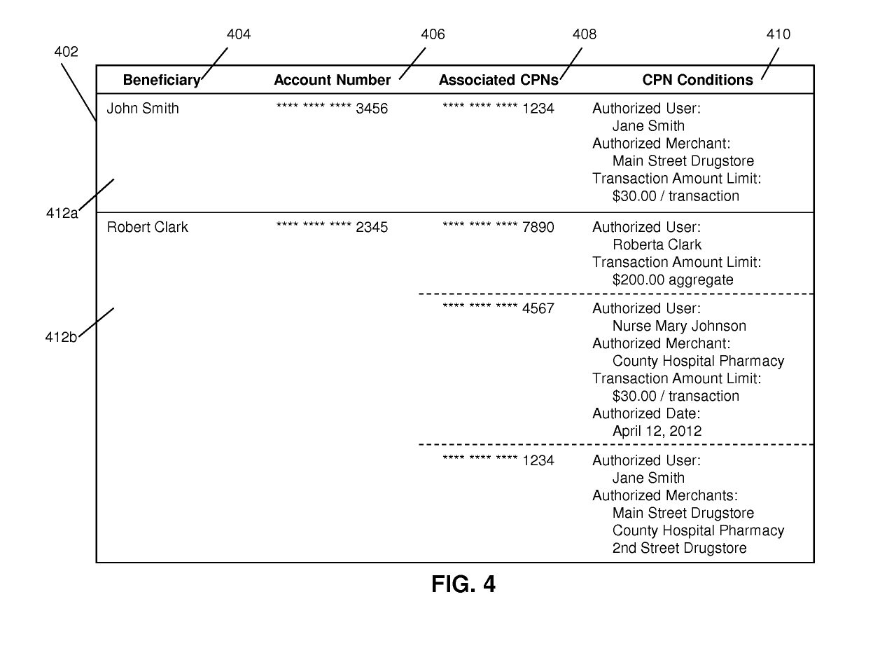

The payment account database 304 may be configured to store a plurality of payment accounts. Each payment account may include at least a payment card number (e.g., a unique number associated with a payment card), at least one controlled payment number, and payment card use condition(s) associated with each of the at least one controlled payment number. In some embodiments, a single payment card number may be associated with multiple controlled payment numbers, as illustrated in FIG. 4 and discussed in more detail below.

Data stored in the conditions database 302 and payment account database 304, or in the financial account database 202 of the benefits agency 102 (the “databases”) may be stored on any type of suitable computer readable media, such as optical storage (e.g., a compact disc, digital versatile disc, blu-ray disc, etc.) or magnetic tape storage (e.g., a hard disk drive). The databases may be configured in any type of suitable database configuration, such as a relational database, a structured query language (SQL) database, a distributed database, an object database, etc. Suitable configurations and database storage types will be apparent to persons having skill in the relevant art. The databases may each be a single database, or may comprise multiple databases which may be interfaced together (e.g., physically or via a network).

The receiving unit 306 may be configured to receive (e.g., from the benefits agency 102) a request for a controlled payment number including a payment card number and at least one payment card use condition (e.g., of the plurality of payment card use conditions stored in the conditions database 302). The processing unit 310 may be configured to identify a controlled payment number. Identification of a controlled payment number may include selecting from a plurality of available controlled payment numbers, generating a controlled payment number, or other methods as will be apparent to persons having skill in the relevant art. The processing unit 310 may store the identified controlled payment number and associated at least one payment card use condition in the payment account database 304 in a payment account corresponding to the payment card number included in the received request.

The transmitting unit 308 may be configured to transmit (e.g., to the benefits agency 102) the identified controlled payment number. In some embodiments, the transmitting unit 308 may also be configured to transmit at least one of the plurality of payment card use conditions stored in the conditions database 302 to the benefits agency 102 (e.g., for selection by the benefits agency and/or beneficiary 108 in creating requests to be transmitted to the financial transaction processing agency 106).

The receiving unit 306 may also be configured to receive (e.g., from the merchant 112) authorization requests for financial transactions, such as an authorization request including a controlled payment number. The processing unit 310 may be configured to identify a controlled payment number in an authorization request and to identify, in the payment account database 304, a payment account associated with the identified controlled payment number. The processing unit 310 may be further configured to process the financial transaction using a payment card number corresponding to the payment account associated with the controlled payment number. Processing of the financial transaction may include transmitting (e.g., via the transmitting unit 308) to the issuer 104 transaction details, such as the amount of the transaction and the payment card number, and receiving (e.g., via the receiving unit 306) a response from the issuer 104. Once the transaction has been processed, the transmitting unit 308 may transmit a response to the authorization request to the merchant 112.

FIG. 4 illustrates a table 402 containing payment account data that may be stored associating controlled payment numbers with payment card numbers (e.g., in the payment account database 304 of the financial transaction processing agency 106 or the financial account database 202 in the benefits agency 102). The table 402 includes payment account data entries 412a and 412b. Each payment account data entry 412 may include a beneficiary 404, an account number 406, associated controlled payment numbers 408, and payment card use conditions 410. In some embodiments, such as in the payment account database 304, the payment account data entry 412 may not include the beneficiary 404.

The account number 406 may be a unique value (e.g., a number) associated with a payment card or a financial account. The associated controlled payment numbers 408 may be controlled payment numbers that are associated with the account number 406 (e.g., by the processing units 208 and 310). Each associated controlled payment number 408 may be similar to the account number 406 (e.g., a similar unique value) but may be subject to the payment card use conditions 410. In some instances, an account number 406 may only be associated with a single controlled payment number 408, as in payment account data entry 412a. In other instances, multiple controlled payment numbers 408 may be associated with a single account number 406, as illustrated in payment account data entry 412b in the table 402.

As discussed above, the payment card use conditions 410 may be conditions that are placed on an associated controlled payment number 408 such that financial transactions entered into using the associated controlled payment number 408 must comply with each payment card use condition 410. Each controlled payment number 408 may be associated with a single payment card use condition 410 or multiple payment card use conditions 410 as will be apparent to persons having skill in the relevant art.

### Distribution of Controlled Payment Numbers

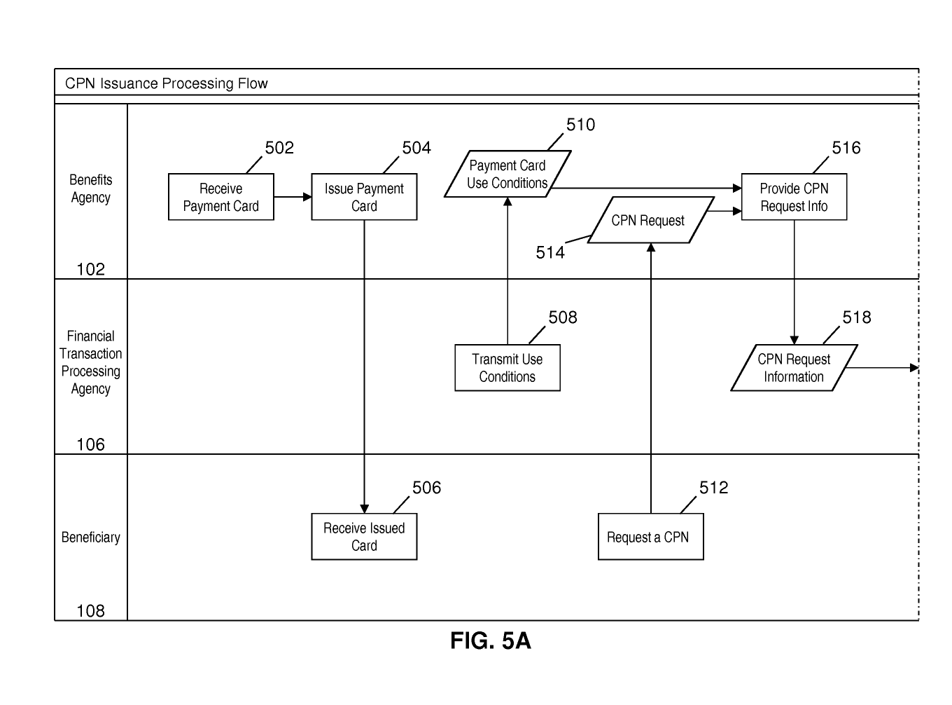

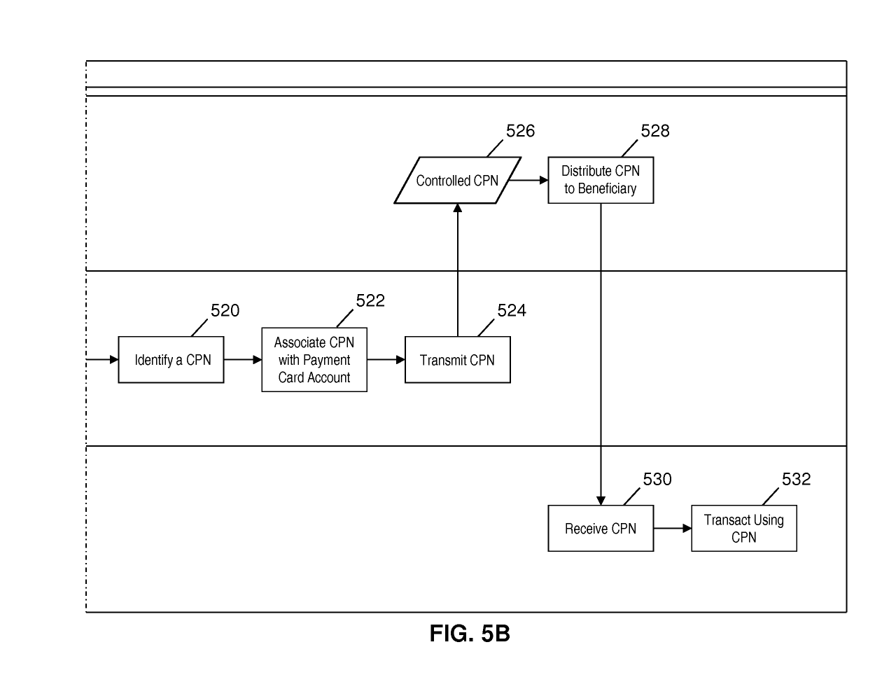

FIGS. 5A and 5B are a flow diagram illustrating the distribution of a controlled payment number by a benefits agency (e.g., the benefits agency 102).

In step 502, the benefits agency 102 may receive (e.g., via the receiving unit 204) a payment card (e.g., from the issuer 104). The received payment card may have an associated payment card number that is unique to the payment card. In step 504, the benefits agency 102 may issue the received payment card to the beneficiary 108, who may receive the issued payment card in step 506. The payment card may be a physical (e.g., plastic) payment card, may be stored and transmitted electronically, etc. for use with a mobile device or for Internet of other e-commerce, of combinations thereof.

In step 508, the financial transaction processing agency 106 may transmit payment card use conditions to the benefits agency 102, who may receive them in step 510. The payment card use conditions may include at least one of authorized users, prohibited user, authorized merchants, prohibited merchants, authorized transaction amounts, authorized dates and/or times, transaction amount limits, number of transaction limits, aggregate transaction amount limits, and geographic restrictions. In one embodiment, the benefits agency 102 may transmit or otherwise make available the payment card use conditions to the beneficiary 108.

In step 512, the beneficiary 108 may request a controlled payment number from the benefits agency 102, who may receive the request in step 514. Methods for submitting and receiving the request for a controlled payment number will be apparent to persons having skill in the art and may include using the Internet (e.g., filling out a form on a website, sending an e-mail request, etc.), telephone (e.g., communicating the request to an operator), mail (e.g., mailing a form request), etc. The request for a controlled payment number may include information identifying the beneficiary 108 (e.g., beneficiary name, associated payment card number, etc.) and at least one payment card use condition the requested controlled payment number will be subject to. In some embodiments, multiple controlled payment numbers and associated payment card use conditions may be requested in a single request.

In step 516, the benefits agency 102 may provide request information for the controlled payment number to the financial transaction processing agency 106, which may receive the request information in step 518. The request information may include at least the payment card number associated with the beneficiary 108 and the at least one payment card use condition indicated by the beneficiary 108 in the request received in step 514. In step 520, the financial transaction processing agency 102 may identify a controlled payment number. In one embodiment, the controlled payment number may be generated by the financial transaction processing agency 102. In another embodiment, the controlled payment number may be selected from a plurality of available controlled payment numbers. In step 522, the financial transaction processing agency 106 may associate, in a database (e.g., the payment account database 304), the identified controlled payment number and associated at least one payment card use condition with the corresponding payment card number.

In step 524, the financial transaction processing agency may transmit the controlled payment number to the benefits agency 102, which may receive the controlled payment number in step 526. Then, in step 528, the benefits agency 102 may distribute the controlled payment number, subject to the at least one payment card use condition, to the beneficiary 108 to be received in step 530. In some embodiments, the controlled payment number may be distributed in the form of a physical payment card (e.g., a plastic credit card, plastic debit card, etc.). In these embodiments, the physical payment card may include the name of the beneficiary 108 as well as relevant payment card use conditions associated with the controlled payment number, such as the name of an authorized user, name of an authorized merchant, etc. For example, the beneficiary 108 may be provided with a payment card to give to the authorized user 110 that is inscribed with the controlled payment number and stating that the card belongs to the authorized user 110 to be used on behalf of the beneficiary 108.

In other embodiments, the controlled payment number may be distributed as a number in a format other than as a payment card, such as via electronic mail, traditional mail, by telephone, etc. In step 532, the beneficiary 108 (e.g., or the authorized user 110 acting on behalf of the beneficiary) may enter into a financial transaction using the controlled payment number.

### Processing a Transaction Including a Controlled Payment Number

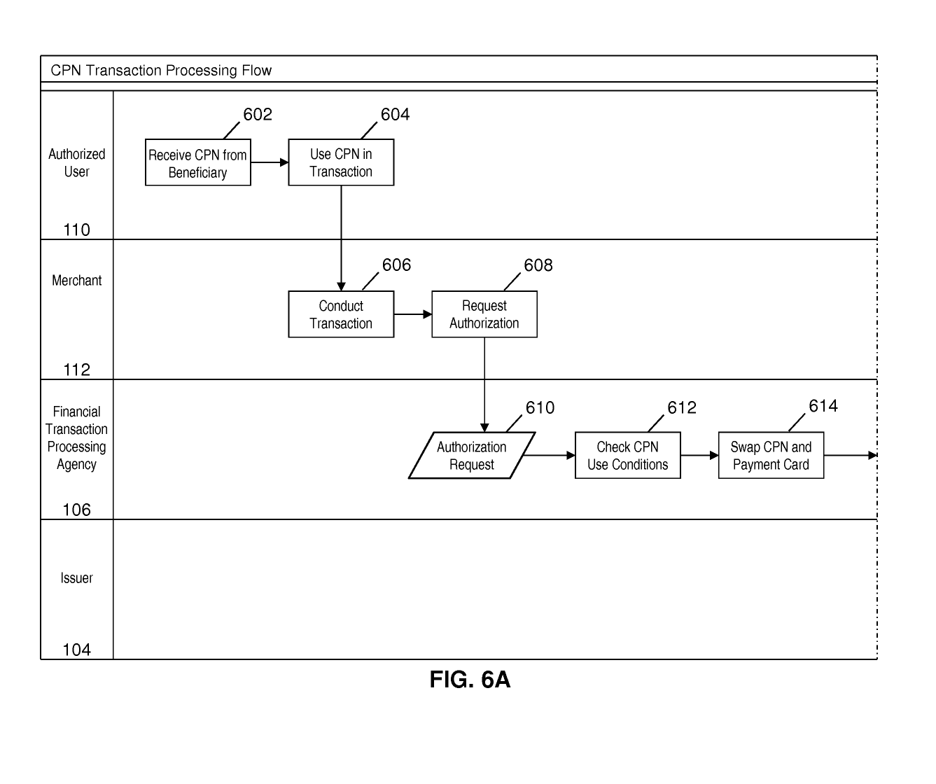

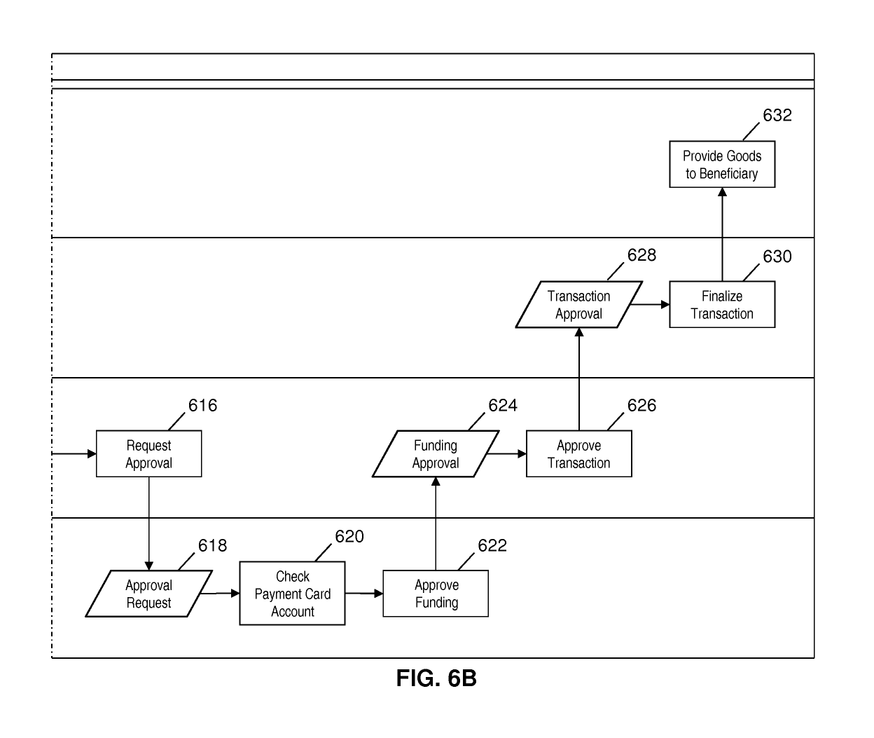

FIGS. 6A and 6B are a flow diagram illustrating a method for processing a financial transaction including a controlled payment number distributed by the benefits agency 102 (e.g., using the method of FIGS. 5A and 5B).

In step 602, the authorized user 110 may receive a controlled payment number from the beneficiary 108. In an exemplary embodiment, the controlled payment number may be in the form of a physical payment card. In a further embodiment, the physical payment card may be inscribed or otherwise indicate the controlled payment number and the authorized user 110, as a form of authentication or authorization to act on behalf of the beneficiary, whose name might also be embossed on the physical card. Similar measures can be used with respect to virtual cards. That is, in an exemplary embodiment, the physical or virtual payment card may also include the name of the beneficiary 108 and/or the authorized user 110. In further embodiments, the use controls can include the identity of the authorized user 110, and electronically transmitted with the authorization request, perhaps after checking physical or electronic identification, depending on the need for certainty. In step 604, the authorized user 110 may use the controlled payment number in a financial transaction with the merchant 112.

In step 606, the merchant 112 may conduct the financial transaction (e.g., using a point-of-sale system). It will be apparent to persons having skill in the relevant art that the financial transaction may take place at a physical location of the merchant 112 or remotely (e.g., via telephone, by mail, or on the Internet). As part of the conducting of the transaction, in step 608 the merchant 112 may submit an authorization request for the transaction to the financial transaction processing agency 106. The authorization request, received by the financial transaction processing agency 106 in step 610, may include at least the controlled payment number. In one embodiment, the authorization request may also include any additional information necessary to evaluate compliance with any payment card use conditions associated with the controlled payment number. In another embodiment, the financial transaction processing agency 106 may identify the payment card use conditions associated with the controlled payment number (e.g., in the payment account database 304) and may request any necessary additional information from the merchant 112 (e.g., who may then prompt the authorized user 110 if necessary).

In step 612, the financial transaction processing agency 106 may check for compliance with payment card use conditions associated with the controlled payment number. For example, the financial transaction processing agency 106 may check the name of the authorized user, the amount of the transaction, and the name of the merchant against those stored in a database as corresponding to the controlled payment number. Suitable methods for checking the compliance of the transaction will be apparent to persons having skill in the relevant art.

If the transaction does not satisfy the payment card use conditions, the financial transaction processing agency 106 may deny the transaction and notify the merchant 112. In one embodiment, the financial transaction processing agency 106 may also notify the beneficiary 108 or the benefits agency 102 (e.g., which may then notify the beneficiary 108). In a further embodiment, the beneficiary 108 may indicate (e.g., in the request for the controlled payment number) criteria and/or methods for notification. For example, the beneficiary 108 may request notification for every denied transaction and for the notification to be sent via a short message service (SMS) message to a mobile device.

In some embodiments, the financial transaction processing agency 106 or the benefits agency 102 may contact the beneficiary 108 when a transaction has been denied and request authorization of the transaction by the beneficiary 108. For example, the benefits agency 102 may call the beneficiary 108 to determine if a transaction conducted by an authorized user should be authorized although the transaction amount is slightly above the authorized amount. In some embodiments, if the authorization request includes detailed transaction data such as product information (e.g., universal product codes, stock-keeping units, etc. of transacted products), the benefits agency 102 may provide the information to the beneficiary 108 for consideration in providing authorization.

If the transaction does satisfy the payment card use conditions associated with the controlled payment number, then, in step 614, the financial transaction processing agency may swap the controlled payment number for the corresponding payment card number (e.g., as stored in the payment account database 304). In step 616, the financial transaction processing agency 106 may request approval of the financial transaction (e.g., based on the transaction amount) from the issuer 104 of the payment card number. The issuer 104 may receive the approval request in step 618 and then, in step 620, check the payment card account corresponding to the payment card number to determine if funding is available.

If funding is available then in step 622, the issuer 104 may transmit approval of the funding to the financial transaction processing agency 106. The financial transaction processing agency 106 may, in step 624, receive the funding approval and may thereby approve the transaction in step 626 and transmit the approval of the transaction in response to the authorization request to the merchant 112. In step 628, the merchant 112 may receive the transaction approval and may finalize the transaction in step 630. Finalizing the transaction may include, in step 632, the merchant 112 providing the transaction goods and/or services to the authorized user 110 (e.g., to be later provided to the beneficiary 108).

In some embodiments, the financial transaction processing agency 106 (e.g., or the benefits agency 102 or merchant 112) may notify the beneficiary 108 of the approval of the transaction. In some embodiments, the financial transaction processing agency 106 or the benefits agency 102 may perform tracking and analysis of transactions conducted with controlled payment numbers for a specific payment card number. For example, the benefits agency 102 may (e.g., via the monitoring unit 210) provide reports to the beneficiary 108 of all authorized and/or denied transactions using controlled payment numbers. In some instances, the benefits agency 102 may provide reports periodically (e.g., weekly, monthly, etc.) or following each transaction. Suitable methods and types of monitoring and reporting to the beneficiary 108 will be apparent to persons having skill in the relevant art.

### Exemplary Computer System Architecture

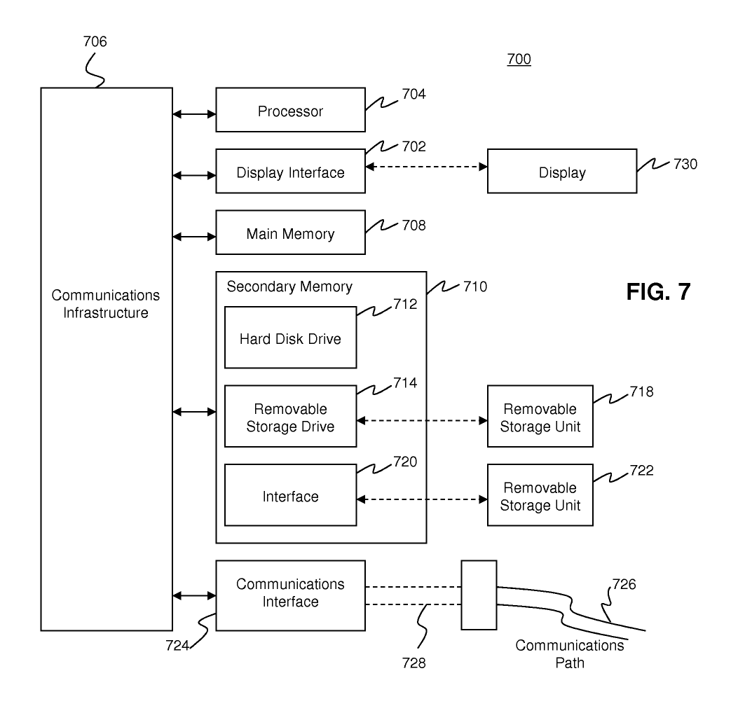

FIG. 7 illustrates a computer system 700 in which embodiments of the present disclosure, or portions thereof, may be implemented as computer-readable code. For example, the financial transaction processing server 106, demographic tracking agency 114, issuer 108, and merchant 104 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 2, 6A, 6B, and 8.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communication infrastructure 706, such as a bus, message queue, network (e.g., the network 118), multi-core message-passing scheme, etc. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive, the removable storage unit 718 may be a floppy disk. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

Computer program medium and computer usable medium may refer to memories, such as the main memory 708 and secondary memory 710, which may be memory semiconductors (e.g. DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 2, 6A, 6B, and 8, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

### Exemplary Method for Distributing a Controlled Payment Number by a Benefits Agency

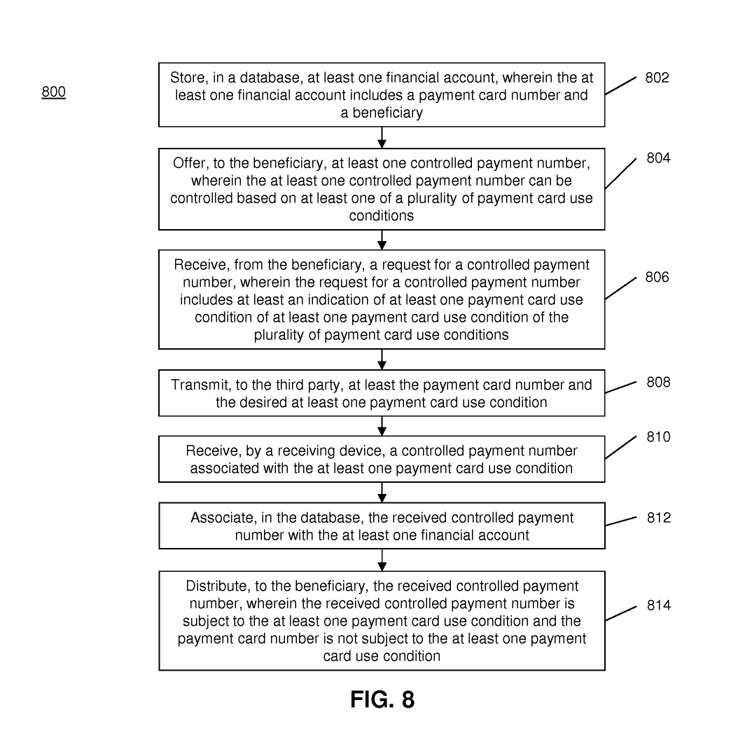

FIG. 8 illustrates a method 800 for the distribution of a controlled payment number by a benefits agency (e.g., the benefits agency 102).

In step 802, at least one financial account (e.g., the payment account data entry 412) may be stored in a database (e.g., the financial account database 202), wherein the at least one financial account includes a payment card number (e.g., the account number 406) and a beneficiary (e.g., the beneficiary 404). In one embodiment, the payment card number may be a unique value associated with a payment card. In some embodiments, the payment card number may correspond to a prepaid payment card.

In step 804, at least one controlled payment number may be offered (e.g., via the transmitting unit 206) to the beneficiary 404, wherein the at least one controlled payment number can be controlled based on at least one of a plurality of payment card use conditions. In one embodiment, the plurality of payment card use conditions may include at least one of: authorized users, prohibited user, authorized merchants, prohibited merchants, authorized transaction amounts, authorized dates and/or times, transaction amount limits, number of transaction limits, aggregate transaction amount limits, and geographic restrictions. In one embodiment, the offer may be made by at least one of: telephone, mail, text message, or the Internet. In some embodiments, the plurality of payment card use conditions offered to the beneficiary 404 may be received from a third party (e.g., the financial transaction processing agency 106).

In step 806, a request for a controlled payment number may be received (e.g., by the receiving unit 204) from the beneficiary 404, wherein the request for a controlled payment number includes at least an indication of at least one payment card use condition (e.g., the associated payment card use condition 410) of the plurality of payment card use conditions. Then, in step 808, at least the payment card number 406 and the desired at least one payment card use condition 410 may be transmitted (e.g., via the transmitting unit 206) to a third party. In one embodiment, the third party may be a financial transaction processing agency (e.g., the financial transaction processing agency 106).

In step 810, the receiving unit 204 may receiving a controlled payment number (e.g., the controlled payment number 408) associated with the at least one payment card use condition 410. In one embodiment, the controlled payment number may be included (e.g., encoded in, displayed on, etc.) a physical payment card. In a further embodiment, the at least one payment card use condition 410 may be indicated on the physical payment card.

In step 812, the received controlled payment number 408 may be associated in the financial account database 202 with the at least one financial account 412. In step 814, the received controlled payment number 408 may be distributed to the beneficiary 404, wherein the received controlled payment number 408 is subject to the at least one payment card use condition 410 and the payment card number 406 is not subject to the at least one payment card use condition 410.

### Exemplary Method for Processing a Financial Transaction Using a Controlled Payment Number

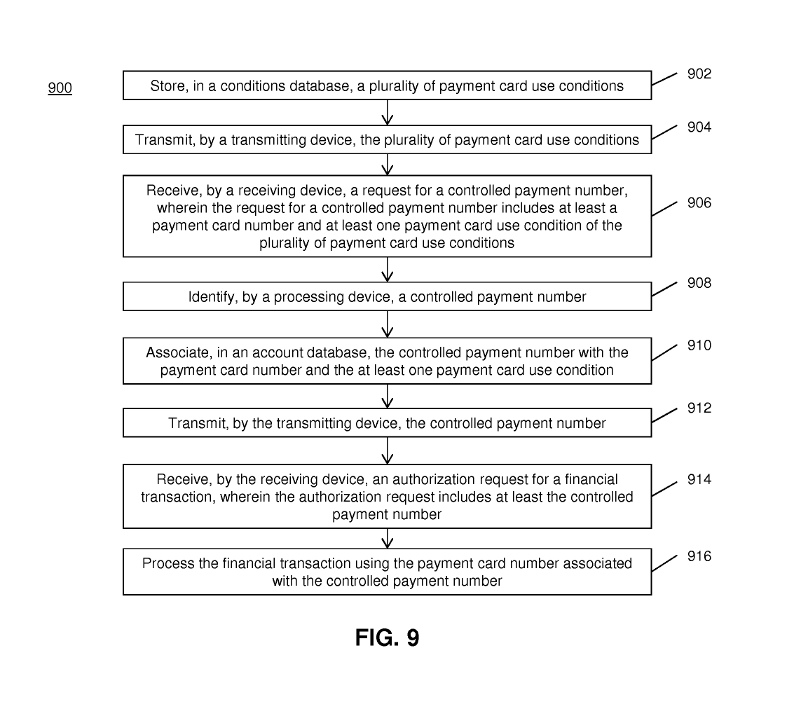

FIG. 9 illustrates a method 900 for processing a financial transaction using a controlled payment number (e.g., a distributed by the benefits agency 102).

In step 902, a plurality of payment card use conditions may be stored in a conditions database (e.g., the conditions database 302). In one embodiment, the plurality of payment card use conditions may include at least one of: authorized users, prohibited user, authorized merchants, prohibited merchants, authorized transaction amounts, authorized dates and/or times, transaction amount limits, number of transaction limits, aggregate transaction amount limits, and geographic restrictions. In step 904, a transmitting device (e.g., the transmitting unit 308) may transmit the plurality of payment card use conditions (e.g., to the benefits agency 102).

In step 906, a receiving device (e.g., the receiving unit 306) may receive a request for a controlled payment number, wherein the request for a controlled payment number includes at least a payment card number (e.g., the account number 406) and at least one payment card use condition (e.g., the associated payment card use condition 410) of the plurality of payment card use conditions. In one embodiment, the payment card number may be a unique value associated with a payment card. In some embodiments, the payment card number may correspond to a prepaid payment card.

In step 908, a processing device (e.g., the processing unit 310) may identify a controlled payment number (e.g., the controlled payment number 408). In step 910, the controlled payment number 408 may be associated, in an account database (e.g., the payment account database 304), with the payment card number 406 and the at least one payment card use condition 410. In step 912, the transmitting unit 308 may transmit the controlled payment number 408 (e.g., to the benefits agency 102). In one embodiment, the controlled payment number may be included in a physical payment card.

In step 914, the receiving unit 306 may receive (e.g., from the merchant 112) an authorization request for a financial transaction, wherein the authorization request includes at least the controlled payment number 408. In one embodiment, the authorization request may further include transaction data corresponding to the at least one payment card use condition 410. In another embodiment, the processing unit 310 may identify the at least one payment card use condition 410 associated with the controlled payment number 408 and request, and subsequently receive, additional transaction data corresponding to the at least one payment card use condition 410. In step 916, the processing unit 310 may process the financial transaction using the payment card number 406 associated with the controlled payment number 408.

Techniques consistent with the present disclosure provide, among other features, systems and methods for distributing content to devices, initiating financial transactions, processing electronic financial transactions using a payer device and pay codes, and indirectly controlling websites. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method of distributing a controlled payment number by a benefits agency, comprising:
storing, in a database, at least one financial account, wherein the at least one financial account includes a payment card number and a beneficiary 404/108;
offering, to the beneficiary, at least one controlled payment number, wherein the at least one controlled payment number can be controlled based on at least one of a plurality of payment card use conditions;
receiving, from the beneficiary, a request for a controlled payment number, wherein the request for a controlled payment number includes at least an indication of at least one payment card use condition of the plurality of payment card use conditions;
transmitting, to the third party, at least the payment card number and the desired at least one payment card use condition;
receiving, by a receiving device, a controlled payment number associated with the at least one payment card use condition;
associating, in the database, the received controlled payment number with the at least one financial account; and
distributing, to the beneficiary, the received controlled payment number,
wherein the received controlled payment number is subject to the at least one payment card use condition and the payment card number is not subject to the at least one payment card use condition

2. The method of claim 1, wherein the payment card number corresponds to a prepaid payment card.

3. The method of claim 1, wherein the third party is a financial transaction processing agency.

4. The method of claim 1, wherein the at least one payment card use condition is a limitation on at least one of: authorized users, authorized merchants, individual transaction amounts, aggregate transaction amounts, dates and/or times of purchases, and geographic location of purchases.

5. The method of claim 1, further comprising:
receiving, from a third party, the plurality of payment card use conditions for offering to the beneficiary.

6. A method of processing a financial transaction using a controlled payment number, comprising:
storing, in a conditions database, a plurality of payment card use conditions;
transmitting, by a transmitting device, the plurality of payment card use conditions;
receiving, by a receiving device, a request for a controlled payment number, wherein the request for a controlled payment number includes at least a payment card number 406 and at least one payment card use condition of the plurality of payment card use conditions;
identifying, by a processing device, a controlled payment number;
associating, in an account database, the controlled payment number with the payment card number and the at least one payment card use condition;
transmitting, by the transmitting device, the controlled payment number;
receiving, by the receiving device, an authorization request for a financial transaction, wherein the authorization request includes at least the controlled payment number; and
processing the financial transaction using the payment card number associated with the controlled payment number.

7. The method of claim 6, wherein the payment card number corresponds to a prepaid payment card.

8. The method of claim 6, wherein the at least one payment card use condition is a limitation on at least one of: authorized users, authorized merchants, individual transaction amounts, aggregate transaction amounts, dates and/or times of purchases, and geographic location of purchases.

9. A system for distributing a controlled payment number by a benefits agency, comprising:
a database configured to store at least one financial account, wherein the at least one financial account includes a payment card number and a beneficiary;
a transmitter configured to transmit, to the beneficiary, a plurality of payment card use conditions for selection in obtaining at least one controlled payment number;
a receiver configured to
receive, from the beneficiary, a request for a controlled payment number, wherein the request for a controlled payment number includes at least an indication of at least one payment card use condition of the plurality of payment card use conditions, and
receive a controlled payment number;
a transmitter configured to transmit, to the third party, at least the payment card number and the desired at least one payment card use condition; and
a processor configured to
associate, in the database, the received controlled payment number with the at least one financial account, and
distribute, to the beneficiary, the received controlled payment number,
wherein the received controlled payment number is subject to the at least one payment card use condition and the payment card number is not subject to the at least one payment card use condition.

10. The system of claim 9, wherein the payment card number corresponds to a prepaid payment card.

11. The system of claim 9, wherein the third party is a financial transaction processing agency.

12. The system of claim 9, wherein the at least one payment card use condition is a limitation on at least one of: authorized users, authorized merchants, individual transaction amounts, aggregate transaction amounts, dates and/or times of purchases, and geographic location of purchases.

13. The system of claim 9, wherein the receiver is further configured to receive, from a third party, the plurality of payment card use conditions for transmitting to the beneficiary.

14. A system for processing a financial transaction using a controlled payment number, comprising:
a conditions database configured to store a plurality of payment card use conditions;
a transmitter configured to transmit the plurality of payment card use conditions;
a receiver configured to receive a request for a controlled payment number, wherein the request for a controlled payment number includes at least a payment card number and at least one payment card use condition of the plurality of payment card use conditions;
a processor configured to
identify a controlled payment number,
associate, in an account database, the controlled payment number with the payment card number and the at least one payment card use condition,
cause the transmitter to transmit the controlled payment number,
cause the receiver to receive an authorization request for a financial transaction, wherein the authorization request includes at least the controlled payment number, and
process the financial transaction using the payment card number associated with the controlled payment number.

15. The system of claim 14, wherein the payment card number corresponds to a prepaid payment card.

16. The system of claim 14, wherein the at least one payment card use condition is a limitation on at least one of: authorized users, authorized merchants, individual transaction amounts, aggregate transaction amounts, dates and/or times of purchases, and geographic location of purchases.
